(19) United States
(12) Patent Application Publication
(10) Pub. No.: US 2010/0176314 A1
(43) Pub. Date: Jul. 15, 2010

(54) Radiation absorber with structural element

(76) Inventor: Peter C. Smith, Half Moon Bay, CA (US)

Correspondence Address: Peter C. Smith, 2411 S. Cabrillo Hwy., Half Moon Bay, CA, 94019, US

(21) Appl. No.: 12/319,872

(22) Filed: Jan. 13, 2009

(51) Int. Cl. G21F 3/00

(52) U.S. Cl. 250/515.1

(57) ABSTRACT

The invention is a composite radiation absorber made up of a rubber or rubber like matrix material filled containing a radiation absorptive element, or a plurality of radiation absorptive elements, combined with a structural member or members that will support the shape and substantial portions of mass of the composite during use. This structural support characteristic offers significant advantages to users in the shielding of undesirable radiation fields in areas not able to support shielding material loads alone. No prior art could be found relating to the useful combination of structural and weight supportive elements used in otherwise flexible composite radiation absorptive materials.

### BRIEF DESCRIPTION OF INVENTION

This invention describes shaped flexible radiation shielding materials (or absorbers) that incorporate a structural backbone structure that allows the absorber to be held or supported in position by external means.

### BACKGROUND AND ADVANTAGES OF INVENTION

Solid radiation absorbers are used extensively in the medical, power generation, and nuclear propulsion, and process industries to shield persons, equipment, and nearby structures from unwanted radiation exposure. Radiation absorbers are often incorporated into structures used to mechanically hold them in place for use as in the case of rolling shields that have a frame and wheels, or as in the case where radiation containment rooms where the absorbers are incorporated into wall, door, and ceiling elements.

Flexible radiation absorbers are also used in cases where conformance, fit, or portability are deemed important as in the case of garments, or where they are used to wrap around irregularly shaped radiation emitting elements as in the case of equipment and piping in nuclear power generation. In some cases a secondary structure is created to support the weight of the absorbers used when the article to be shielded cannot adequately bear this additional weight as in the case of nuclear power generation where the weight of lead blanket absorbers is to much for piping systems to support.

Also in the cases of medical or veterinary procedure, it is sometimes advantageous to have the absorber not touch an area where there is a wound, infection, or where the body would be sensitive to the deformation caused by the weight of the absorber.

These and other limitations constitute a significant restriction to the use of flexible radiation absorbers. This invention discloses art defining the makeup and construction of alternative flexible absorbers that contain rigid and or deformable members that can be used to self support these absorber structures.

### DESCRIPTION OF MANNER AND PROCESS OF MAKING AND USING THE INVENTION

Flexible radiation absorbers are made up of radiation absorptive elements dispersed into a flexible rubber like matrix. This construction is described elsewhere. The mixture retains flexibility imparted by the rubber-like matrix while benefiting for radiation absorption imparted by the filler or fillers. The rubber-like matrix can be from a selection from a wide range of materials including but not limited to natural rubbers and latexes, or thermoplastic, thermo-set, or reaction cure polymers. Absorptive elements can be powders, granules, strips, plates, or similar elements containing element effective in capturing the radiation of interest. These additives are typically individually prepared, then mixed or otherwise blended together, and formed into finished shapes by bonding, casting, rolling, spaying or other conventional polymer fabrication means. In some cases the absorber can be made from multiple layers of themselves homogeneous mixtures of rubber-like and absorptive elements, but the layers in themselves will have compositions different from each other. In these layered cases, each sequential layer is formed into or around the prior layer. Typically, but not always, the structural element is formed into the outermost layer.

In the case of this invention a structural element or elements are formed into the rubber like matrix shape to become a permanent part if it after cure.

In all cases this structural element or elements will have at least one area of structural support that extends to the outside to allow attachment to and external support

### DRAWINGS AND DESCRIPTIONS OF THE INVENTION

FIG. 1 shows a simple tubular flexible absorber made up of a mixture of flexible and radiation absorptive elements (1), and incorporates a bonded structural backbone with the capacity to support the finished weight of the entire structure (2), said backbone having various external attachment points (3). In FIG. 1 the is shown as a single one, but as in the case of this and other figures, multiple backbone elements are also possible and may be advantageous.

FIG. 2. shows a variation of FIG. 1 where the flexible absorptive elements (1), an attachment point is a tubular surface (2) that is a portion of the backbone element (3). This tube or shaft can be used as the external attachments point

FIG. 3. shows an absorber with homogeneous flexible element (1) with two structural backbones (2) that also act to assist as a means to conveniently open the absorptive element during installation as well as providing a mounting points (3) following installation.

FIG. 4. is provided to clarify the method by which the absorber in FIG. 3. would be held open to install it on a cylindrical surface (4).

FIG. 5. is a variation of FIG. 3. where for very large absorber pieces, some benefit in handling and or installation may be derived from having a multi-piece structure with integral backbone elements that themselves also allow on site assembly to occur (5).

FIG. 6. is a variation of FIG. 3. where the shape of the article being shielded makes absorber installation difficult as in the case of this pipe elbow. The use of structural backbones can assist in installation, with the addition of installation loops (6) that keep the pieces together but can be removed later.

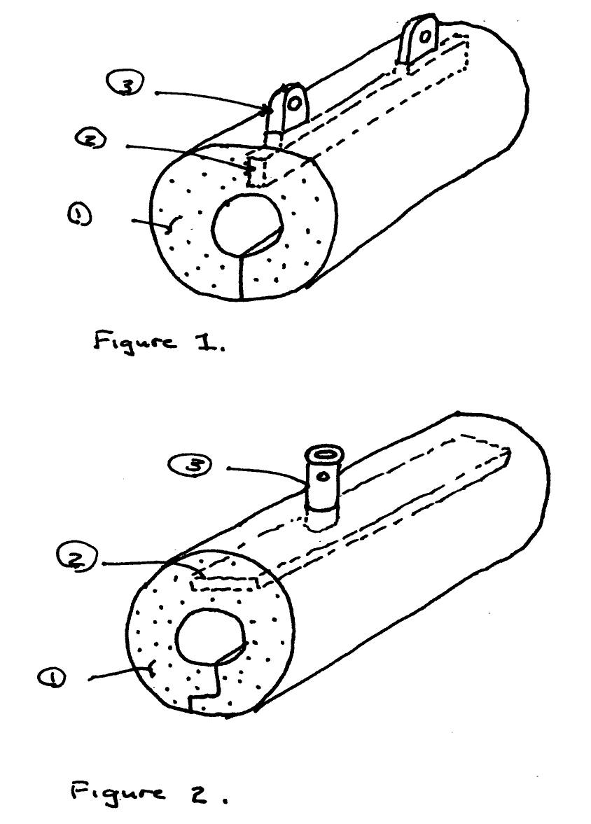

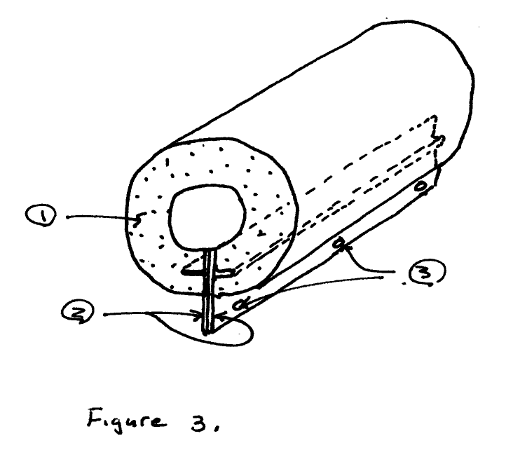

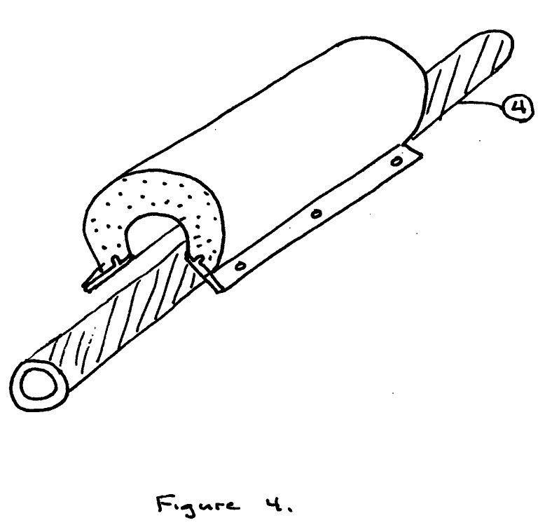

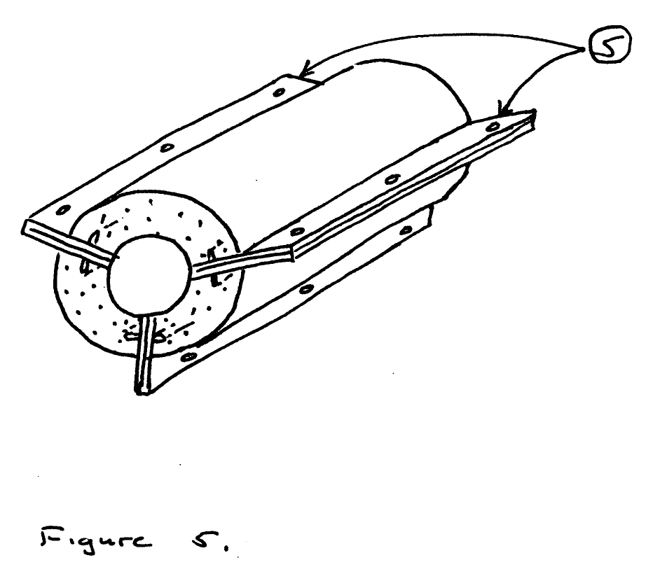

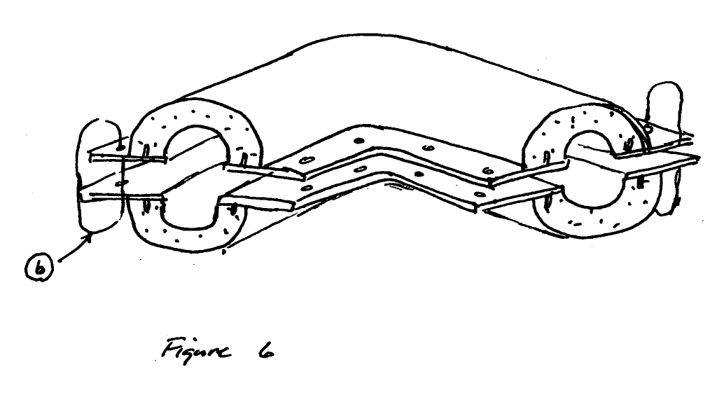

What is claimed is:

1. A composite radiation absorber made up of a rubber or rubber like matrix material bonded to powdered or granular, or otherwise shaped radiation absorptive filler material, combined with a structural backbone element or elements suitable to both support the weight of the structure and provide an external attachment point or points.
